(19) United States
(12) Patent Application Publication
(10) Pub. No.: US 2021/0089602 A1
(43) Pub. Date: Mar. 25, 2021

(54) TUNING MODEL PARAMETERS TO OPTIMIZE ONLINE CONTENT

(71) Applicant: Microsoft Technology Licensing, LLC, Redmond, WA (US)

(72) Inventors: Kinjal Basu, Stanford, CA (US); Viral Gupta, Sunnyvale, CA (US); Yunbo Ouyang, Sunnyvale, CA (US); Cyrus DiCiccio, Palo Alto, CA (US)

(21) Appl. No.: 16/575,862

(22) Filed: Sep. 19, 2019

(51) Int. Cl. G06F 16/9536; H04L 29/08

(52) U.S. Cl. CPC G06F 16/9536; H04L 67/22

(57) ABSTRACT

Techniques for tuning model parameters to optimize online content are disclosed herein. In some embodiments, a computer system receives logged data for cohorts of users, where the logged data of each one of the plurality of cohorts comprises a number of impressions of online content to the cohort, parameter values applied to objective functions of a model used in selecting the online content for the impressions, contribution actions by the cohort directed towards the online content, and clicks by the cohort directed towards the online content. The computer system, for each cohort, selects one of the parameter values for each objective function based on the logged data. The computer system then selects at least one content item for display to a target user based on the model using the parameter values corresponding to the cohort of the target user.

### TECHNICAL FIELD

The present application relates generally to systems and methods, and computer program products for tuning model parameters to optimize online content.

### BACKGROUND

Current solutions for generating models for selecting which online content items to display to a user of an online service suffer from a lack of accuracy (e.g., relevancy), scalability, and efficiency. For example, these solutions fail to adequately optimize a model for multiple objective functions and constraints. The models are often based on multi-dimensional functions, making the configuration of such models extremely complex and difficult to perform with accuracy and effectiveness.

As a result, much of the online content presented to users are not relevant to the user. Irrelevant online content results in technical problems for the computer systems of networked services, as well as for the client devices interacting with the networked services. Users are often forced to navigate through irrelevant online content items to find the online content items that are relevant to them. Additionally, displaying irrelevant content items to users before content items that are relevant to the users is a waste of real estate on the screen of the computing devices on which the online content items are displayed, which is especially troublesome for use cases involving a smartphone or other mobile device with a small screen size. As another example, displaying irrelevant online content items to users leads to undesirable consumption of electronic resources, such as bandwidth, power of the computing devices on which the online content items are displayed, and processor workload of the computing devices on which the online content items are displayed. As a result, the functioning of the computing devices is negatively affected. Other technical problems may arise as well.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating components of a recommendation system, in accordance with an example embodiment.

FIG. 4 illustrates a table of tracking data for a cohort of users of an online service, in accordance with an example embodiment.

FIG. 5 illustrates a table of tuned model parameters, in accordance with an example embodiment.

FIG. 6 is a flowchart illustrating a method of tuning model parameters to optimize online content, in accordance with an example embodiment.

FIG. 7 is a flowchart illustrating a method of selecting, for each one of a plurality of cohorts, one of a plurality of parameter values for each one of a plurality of objective functions, in accordance with an example embodiment.

FIG. 8 is a block diagram of an example computer system on which methodologies described herein may be executed, in accordance with an example embodiment.

### DETAILED DESCRIPTION

I. Overview

Example methods and systems of tuning model parameters to optimize online content are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein. The implementation of the features disclosed herein involves a non-generic, unconventional, and non-routine operation or combination of operations. In some example embodiments, a specially-configured computer system breaks down the overall problem formulation of a model into segments, dividing global parameters into finer level parameters for each objective function of the model and tuning each finer level parameter using personalization based on cohorts of users.

In some example embodiments, the computer system obtains tracking data (also referred to herein as “logged data”) for a plurality of cohorts of users of an online service. In some example embodiments, in order to obtain tracking data of a user, the computer system (or another computer system) requests permission from the user to collect and use such data. If the user agrees to permit the collection and use of such data, then such data of the user is collected and used for further processing, as disclosed herein. In this way, the user controls what information of the user is collected and used by the computer system, as the data of a user is only tracked if the user knowledgeably consents to such data gathering. The tracking data of each cohort comprises a number of impressions of online content to the cohort (e.g., indications of each time online content was displayed to a user of the cohort), a plurality of parameter values applied to a plurality of objective functions of a model used in selecting the online content for the impressions of the online content to the cohort (e.g., what parameters were used in the model that resulted in the online content being displayed to the user of the cohort), a number of contribution actions by the cohort directed towards the online content in response to the impressions (e.g., indications of the user of the cohort liking, commenting on, or sharing the online content in response to the display of the online content), and a number of clicks by the cohort directed towards the online content in response to the impressions (e.g., indications of the user clicking on a user interface element representing the online content in response to the display of the online content). For each one of the cohorts, the computer system selects one of the parameter values for each one of the plurality of objective functions based on the tracking data, and then stores the selected parameter value for each one of the objective functions in a database. When the computer system attempt to select online content to display to a target user, the computer system identifies the selected parameter value for each one of the objective functions for the target user based on the cohort to which the target user belongs, and then selects at least one content item for display to the target user based on the model using the identified selected parameter values for each one of the objective functions of the model.

By applying one or more of the solutions disclosed herein, the computer system simplifies a complex problem of tuning model parameters, estimating multiple one-dimensional functions rather than estimating one multi-dimensional function, achieving faster convergence in tuning the model parameters, and improving the accuracy and effectiveness of models based on the improved tuning of the model parameters, thereby improving the relevance and effectiveness of the presentation of online content based on such models. As a result, some technical effects include improved accuracy of relevance prediction for models and reduction of excessive consumption of electronic resources associated with presentation of irrelevant online content. As a result, the functioning of the computer system and the functioning of the client devices interacting with the computer system are improved. Other technical effects will be apparent from this disclosure as well.

II. Detailed Example Embodiments

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

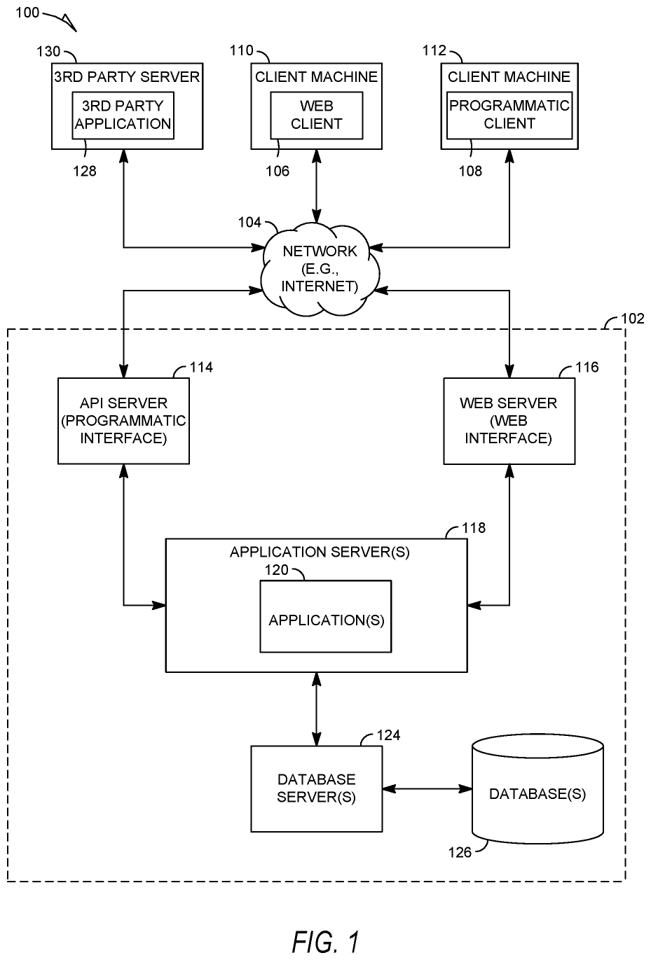

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third-party application 128, executing on a third-party server machine 130, as having programmatic access to the networked system 102 via the programmatic interface provided by the API server 114. For example, the third-party application 128 may, utilizing information retrieved from the networked system 102, support one or more features or functions on a website hosted by the third-party. The third-party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

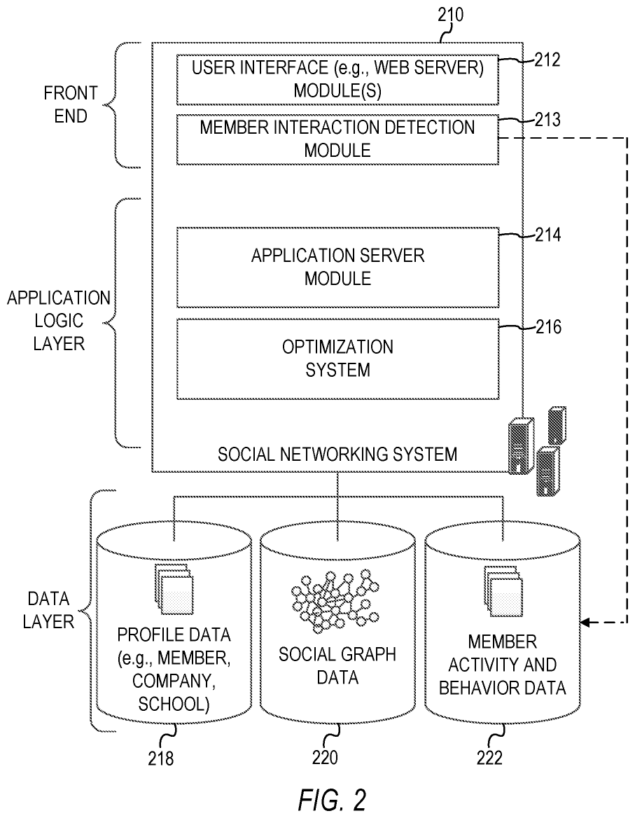

In some embodiments, the networked system 102 may comprise functional components of a social networking service. FIG. 2 is a block diagram showing the functional components of a social networking system 210, including a data processing module referred to herein as a optimization system 216, for use in social networking system 210, consistent with some embodiments of the present disclosure. In some embodiments, the optimization system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the optimization system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222. This logged activity information may then be used by the optimization system 216. The members' interactions and behavior may also be tracked, stored, and used by the optimization system 216 residing on a client device, such as within a browser of the client device, as will be discussed in further detail below.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third-party applications and services.

Although the optimization system 216 is referred to herein as being used in the context of a social networking service, it is contemplated that it may also be employed in the context of any web site or online services. Additionally, although features of the present disclosure can be used or presented in the context of a web page, it is contemplated that any user interface view (e.g., a user interface on a mobile device or on desktop software) is within the scope of the present disclosure.

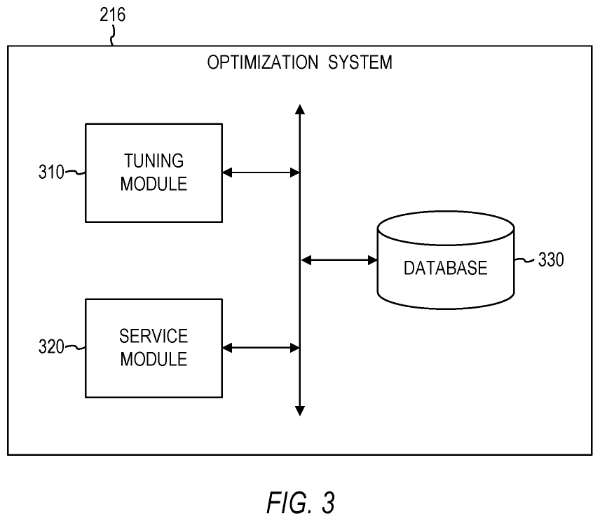

FIG. 3 is a block diagram illustrating components of an optimization system 216, in accordance with an example embodiment. In some embodiments, the optimization system 216 comprises any combination of one or more of a tuning module 310, a service module 320, and one or more database(s) 330. The tuning module 310, the service module 320, and the database(s) 330 can reside on a computer system, or other machine, having a memory and at least one processor (not shown). In some embodiments, the tuning module 310, the service module 320, and the database(s) 330 can be incorporated into the application server(s) 118 in FIG. 1. In some example embodiments, the database(s) 330 is incorporated into database(s) 126 in FIG. 1 and can include any combination of one or more of databases 218, 220, and 222 in FIG. 2. However, it is contemplated that other configurations of the tuning module 310, the service module 320, and the database(s) 330, are also within the scope of the present disclosure.

In some example embodiments, one or more of the tuning module 310 and the service module 320 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the tuning module 310 and the service module 320 is configured to receive user input. For example, one or more of the tuning module 310 and the service module 320 can present one or more GUI elements (e.g., drop-down menu, selectable buttons, text field) with which a user can submit input.

In some example embodiments, one or more of the tuning module 310 and the service module 320 is configured to perform various communication functions to facilitate the functionality described herein, such as by communicating with the social networking system 210 via the network 104 using a wired or wireless connection. Any combination of one or more of the tuning module 310 and the service module 320 may also provide various web services or functions, such as retrieving information from the third party servers 130 and the social networking system 210. Information retrieved by the any of the tuning module 310 and the service module 320 may include profile data corresponding to users and members of the social networking service of the social networking system 210.

Additionally, any combination of one or more of the tuning module 310 and the service module 320 can provide various data functionality, such as exchanging information with database(s) 330 or servers. For example, any of the tuning module 310 and the service module 320 can access member profiles that include profile data from the database(s) 330, as well as extract attributes and/or characteristics from the profile data of member profiles. Furthermore, the one or more of the tuning module 310 and the service module 320 can access social graph data and member activity and behavior data from database(s) 330, as well as exchange information with third party servers 130, client machines 110, 112, and other sources of information.

In some example embodiments, the optimization system 216 is configured to automatically tune models for optimizing the online content presented to users of an online service. Current automated model tuning algorithm are designed using a black box optimization approach where the structure of the problem is not known. The input provided may include a set of utilities and a set of parameters. The black-box design assumes that all utilities are functions of all parameters. However, in many practical situations, there is not really a fully black-box, as a lot more about the structure of the problem is actually known. For example, instead of modelling f(a₁, . . . , aₖ) as a function of k variables, if we know that f(a₁, . . . , aₖ)=Σₖfₖ(aₖ), then, we should model it better. Fitting k univariate functions is much simpler than trying to fit a k-dimensional function.

In some example embodiments, the optimization system 216 implements system architectural changes to enable consumption of such information as well as the impact it can have on online services, such as a user's online data feed. Consider the following optimization problem for a feed system where the objective is to maximize the total contributions (e.g., likes, comments, shares) such that the total clicks are above a threshold. Mathematically, this problem can be written as:

$$Max {\sum }_{m} Contributions ( m )$$

$$s . t . {\sum }_{m} Clicks ( m ) > T ,$$

where m denotes a user. The following scoring function may be used to solve this optimization problem:

Score(m)=Pcontribute(m)+a×PClick(m),

where a corresponding score is generated for each online content item that is being considered for display to the user m.

Since all feed rankings are a function of the parameter a, the optimization system 216 can use f(a) as the function for total contributions and g(a) as the function for total clicks. Thus, the original problem translates to finding the optimal parameter a such that we maximize f(a) under the constraint that g(a)>T. The original approach allowed for the solving of the problem by considering both functions f and g as black-box as functions. However, that is not the case in reality.

The optimization system 216 can significantly improve the situation by not assigning the global a, but by assigning a different parameter a_{c} to a cohort of users c. Thus, the optimization system 216 can break the users into different groups and assign a different parameter to each group. The optimization problem becomes:

$$Max {\sum }_{c} {\sum }_{m ∈ c} Contributions ( m , c )$$

$$s . t . {\sum }_{c} {\sum }_{m ∈ c} Clicks ( m , c ) > T ,$$

where c denotes a group of members. The corresponding scoring function is then:

Score(m,c)=Pcontribute(m, c)+a_{c}×PClick(m, c).

Now, the overall functions can be written as:
the total contributions as f(a₁, . . . , aₖ)=Σ_{c}f_{c}(a_{c}), and
the total clicks as g(aᵢ, . . . , aₖ)=Σ_{c}g_{c}(a_{c}).
   Therefore, instead of solving the black box function:

Max f(a₁, . . . , aₖ) s.t. g(a₁, . . . , aₖ)>T,

the optimization system 216 uses the structure information to solve the equivalent problem:

MaxΣ_{c}f_{c}(a_{c}) s.t. Σ_{c}g_{c}(a_{c})>T

Some technical benefits of this are approach are simplification of the problem by estimating multiple one-dimensional functions rather than estimating one k-dimensional function, achievement of faster convergence for tuning model parameters, the user experience is improved since the optimization system 216 does not have to perform exploration in a high dimensional space, and improved user experience due to more accurate, relevant, and effective online content selection.

The problem can be specified as: Y₁^{c} (a_{c}) is the sum of all contributions received on a cohort c by applying control parameter value a_{c}, and Y₂^{c} (a_{c}) is the sum of all clicks received on a cohort c by applying control parameter value a_{c}. By approaching the problem in this way, the tuning of the control parameter a_{c} only affects metrics for cohort c and does not impact metrics for any other cohort. Y₁^{c} (a_{c}) and Y₂^{c}(a_{c}) can be modelled as:

Y₁^{c}(a_{c})−Gaussian(f_{c}(a_{c}), σ₁²), and

Y₂^{c}(a_{c})−Gaussian(g_{c}(a_{c}), σ₂²),

where σ is the variance, and f_{c} and g_{c} are chosen to have Gaussian Process priors. Thus, the overall optimization problem can be written as:

MaxΣ_{c}f_{c}(a_{c}) s.t. Σ_{c}g_{c}(a_{c})>T,

which can be solved by estimating each of the functions f_{c} and g_{c} for all c∈Cc∈C.

In some example embodiments, the tuning module 310 is configured to obtain, retrieve, or otherwise receive tracking data for a plurality of cohorts of users of an online service. The tracking data may be stored in and retrieved from the database(s) 330. In some example embodiments, the plurality of cohorts comprises different cohorts that correspond to different levels of interaction of the users with the online service. For example, a first cohort may comprise a grouping of users that are identified based on the users of the first cohort interacting with the online service daily, a second cohort may comprise a grouping of users that are identified based on the users of the second cohort interacting with the online service weekly, a third cohort may comprise a grouping of users that are identified based on the users of the third cohort interacting with the online service monthly, and a fourth cohort may comprise a grouping of users that are identified based on the users of the fourth cohort having not interacted with the online service within the last year. Other types of cohorts are also within the scope of the present disclosure, including, but not limited to, cohorts based on similar user profile attributes (e.g., same industry).

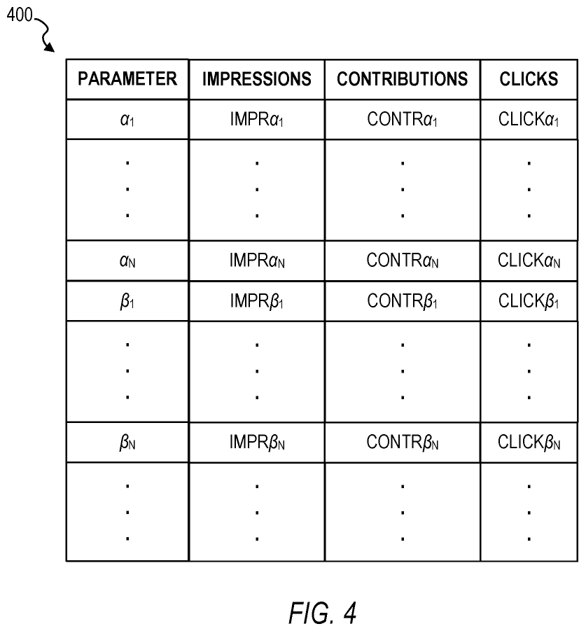

In some example embodiments, the tracking data of each one of the plurality of cohorts comprise a number of impressions of online content to the cohort, a plurality of parameter values applied to a plurality of objective functions of a model used in selecting the online content for the impressions of the online content to the cohort, a number of contribution actions by the cohort directed towards the online content in response to the impressions, and a number of clicks by the cohort directed towards the online content in response to the impressions. FIG. 4 illustrates a table 400 of tracking data for a cohort of users of an online service, in accordance with an example embodiment. In FIG. 4, for each parameter (e.g., α, β) of objective functions of a model that was used to select online content items for display to users of the cohort, such as by scoring the online content items and selecting a portion of the online content items based on their scores, the tracking data includes the different parameter values (e.g., a₁ . . . a_{N}, ⊕₁ . . . β_{N}) that were used by the model in the selection of online content items for display. The use of each parameter value resulted in impressions of online content items for the cohort, and the number of impressions corresponding to each parameter value is indicated in the tracking data for the cohort (e.g., IMPRa₁ . . . IMPRa_{N}, IMPRβ₁ . . . β_{N}).

The tracking data also includes corresponding indications of the number of contribution actions by users of the cohort in response to the impressions (e.g., CONTRa₁ . . . CONTRa_{N}, CONTRβ₁ . . . CONTRβ_{N}). Contribution actions are online actions performed by a user that contribute to viral activity for an online content item. Examples of contribution actions include, but are not limited to, liking, commenting on, or sharing an online content item. Other types of contribution actions are also within the scope of the present disclosure.

The tracking data also includes corresponding indications of the number of clicks by users of the cohort in response to the impressions (e.g., CLICKa₁ . . . CLICKa_{N}, CLICKβ₁ . . . CLICKβ_{N}). A click is a selection by a user of a user interface element representing the online content item, such as the user selecting a representation of a news article on the user's feed to view the entire news article.

In some example embodiments, the tuning module 310 is configured to automatically retrieve the tracking data. For example, the tuning module 310 may use a configuration file to direct an automated scheduled retrieval of the tracking data from the database(s) 330. The configuration file may specify the cohorts for which the tracking data is to be retrieved, a range for the parameters to retrieve (e.g., an upper boundary or threshold for the parameter values and a lower boundary or threshold for the parameter values), and the type of user action data to retrieve (e.g., click count, contribution action count).

In some example embodiments, the tuning module 310 is configured to, for each one of the plurality of cohorts, select one of the plurality of parameter values for each one of the plurality of objective functions based on the tracking data. The plurality of objective functions may correspond to different types of online content. For example, one objective function may be directed towards maximizing clicks on online content items shared by users, while another objective function may be directed towards maximizing applications to an online job posting, while yet another objective function may be directed towards maximizing establishing connections between users of the online service.

In some example embodiments, the tuning module 310 is configured to select the parameter values for the objective functions by performing an iterative process in which, for each one of the plurality of objective functions, a corresponding evaluation value is generated for each one of the plurality of parameter values based on the tracking data, and then, for each one of the plurality of objective functions, a subset of the plurality of parameter values is selected based on the evaluation values of the subset. For example, in a situation where there are three parameter values for an objective function, the tuning module 320 may generate corresponding evaluation values for the parameter values, and then select the two parameter values with the highest evaluation values. The tuning module 320 may then repeat the generation of the corresponding evaluation values for the selected two parameter values, and then select the parameter value with the highest evaluation value. In some example embodiments, the tuning module 310 is configured to repeat the generating of the corresponding evaluation value and the selecting the subset of the plurality of parameter values until a single parameter value satisfies a convergence criteria, with each repeated generating the corresponding evaluation value using the most recently selected subset of parameter values in place of the plurality of parameter values. In some example embodiments, the convergence criteria comprises the selected subset of parameter values comprising only the single parameter value.

In some example embodiments, the tuning module 310 is configured to select the parameter values using a Gaussian process algorithm. A Gaussian process is a collection of random variables indexed by time or space, such that every finite collection of those random variables has a multivariate normal distribution (e.g., every finite linear combination of them is normally distributed). The distribution of a Gaussian process is the joint distribution of all those random variables, and as such, it is a distribution over functions with a continuous domain (e.g., time or space). A machine-learning algorithm that involves a Gaussian process uses lazy learning and a measure of the similarity between points to predict the value for an unseen point from training data.

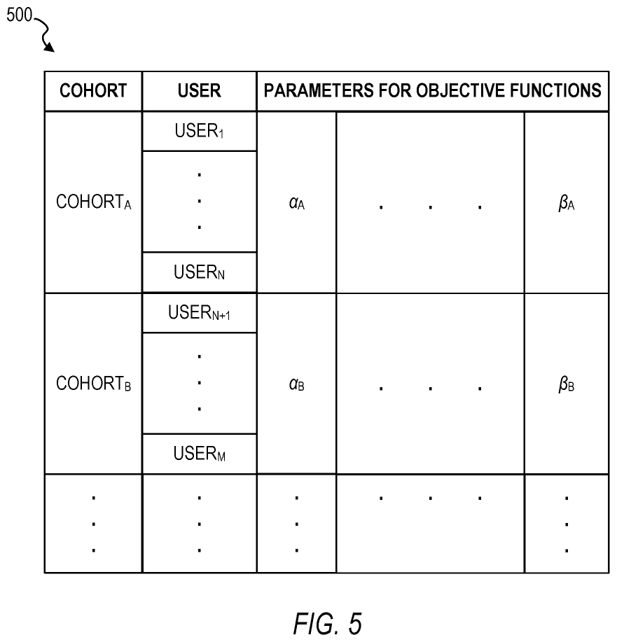

In some example embodiments, the tuning module 310 is configured to, for each one of the plurality of cohorts, store the selected parameter value for each one of the objective functions in a database, such as in the database(s) 330 in FIG. 3, for subsequent retrieval and use in selecting online content items to display to users of the cohort. FIG. 5 illustrates a table 500 of tuned model parameters, in accordance with an example embodiment. The table 500 includes corresponding indications of each cohort in the plurality of cohorts (e.g., COHORT_{A}, COHORT_{B}, . . . ), as well as indications of which users belong to which cohort (e.g., USER₁ . . . USER_{N} belonging to COHORT_{A}, USER_{N+1} . . . USER_{M} belonging to COHORT_{B}, . . . ). Additionally, the table 500 includes, for each cohort, the corresponding parameter values for each objective function (e.g., α_{A} . . . β_{A} for the objective functions for COHORT_{A}, α_{B} . . . β_{B} for the objective functions for COHORT_{B}, . . . ).

In some example embodiments, the service module 320 is configured to determine which online content items to display to a target user. The service module 320 may identify the corresponding parameter value for each one of the objective functions for the target user of the online service based on the cohort to which the target user belongs, such as by accessing the information of the table 500 stored in the database(s) 330. For example, the service module 320 may determine that the target user belongs to COHORT_{B}, and then find the corresponding parameter values α_{B} . . . β_{B} for the objective functions for COHORT_{B}.

In some example embodiments, the service module 320 is configured to select at least one content item for display on a computing device of the target user based on the model using the identified selected parameter values for each one of the objective functions of the model. For example, the service module 320 may generate corresponding scores for each online content items being considered for selection based on the model using the identified selected parameter values for each one of the objective functions of the model, and then select at least one of the online content items based on the generated scores, such as by selecting the top N ranked online content items in terms of scores, where N is a positive integer (e.g., selecting the top five highest scoring online content items).

In some example embodiments, the service module 320 is configured to cause the selected content item(s) to be displayed on the computing device of the target user. For example, the service module 320 may cause the selected content item(s) to be displayed on a data feed of the target user or in an e-mail transmitted to the target user. Other ways of displaying the selected content item(s) to the target user are also within the scope of the present disclosure.

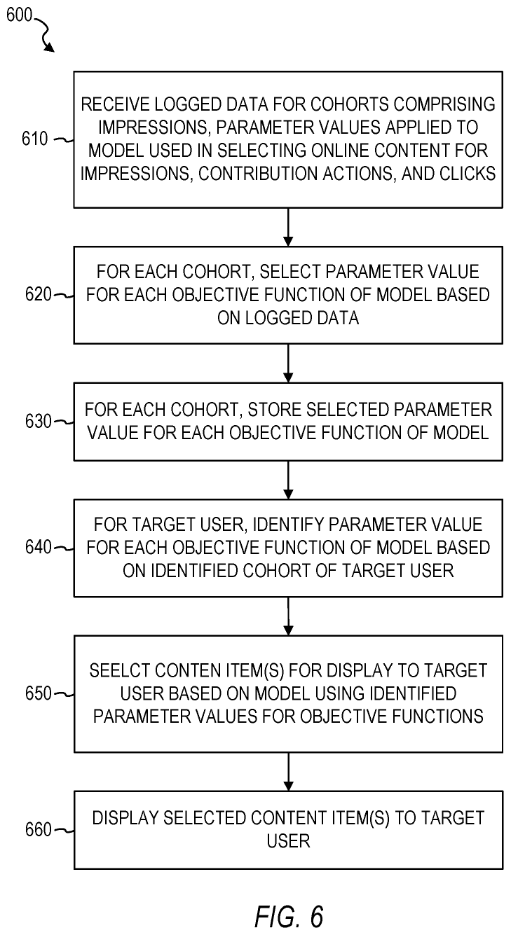

FIG. 6 is a flowchart illustrating a method 600 of tuning model parameters to optimize online content, in accordance with an example embodiment. The method 600 can be performed by processing logic that can comprise hardware (e.g., circuitry, dedicated logic, programmable logic, microcode, etc.), software (e.g., instructions run on a processing device), or a combination thereof. In one implementation, the method 600 is performed by the optimization system 216 of FIGS. 2-3, or any combination of one or more of its modules (e.g., the tuning module 310, the service module 320), as described above.

At operation 610, the optimization system 216 receives tracking data for a plurality of cohorts of users of an online service. In some example embodiments, the tracking data of each one of the plurality of cohorts comprises a number of impressions of online content to the cohort, a plurality of parameter values applied to a plurality of objective functions of a model used in selecting the online content for the impressions of the online content to the cohort, a number of contribution actions by the cohort directed towards the online content in response to the impressions, and a number of clicks by the cohort directed towards the online content in response to the impressions. The plurality of cohorts may comprise different cohorts that correspond to different levels of interaction of the users with the online service. However, other types of cohorts are also within the scope of the present disclosure. In some example embodiments, the plurality of objective functions correspond to different types of online content. For example, the different types of online content may comprise two or more of online content shared by a user, online job postings, and recommendations for connecting with a user. However, other types of online content are also within the scope of the present disclosure. In some example embodiments, the contribution actions comprise at least one of liking online content, commenting on online content, and sharing online content. However, other types of contribution actions are also within the scope of the present disclosure.

At operation 620, the optimization system 216, for each one of the plurality of cohorts, selects one of the plurality of parameter values for each one of the plurality of objective functions based on the tracking data. The plurality of objective functions may correspond to different types of online content. For example, one objective function may be directed towards maximizing clicks on online content items shared by users, while another objective function may be directed towards maximizing applications to an online job posting, while yet another objective function may be directed towards maximizing establishing connections between users of the online service. The tracking data for each parameter value may be used to determine which parameter value best achieves the objective function, such as which parameter value is associated via its tracking data with highest number of clicks on online content items shared by users.

At operation 630, the optimization system 216, for each one of the plurality of cohorts, stores the selected parameter value for each one of the objective functions in a database. For example, the optimization system 216 may store the selected parameter values in the database(s) 330 for subsequent retrieval and use.

At operation 640, the optimization system 216 identifies the selected parameter value for each one of the objective functions for a target user of the online service based on an identified cohort for the target user. For example, the optimization system 216 may access the table 500 in FIG. 5 to determine which cohort a user belongs to and what parameter values correspond to that cohort.

At operation 650, the optimization system 216 selects at least one content item for display on a computing device of the target user based on the model using the identified selected parameter values for each one of the objective functions of the model. For example, the optimization system 216 may generate corresponding scores for each one of a plurality of content items using the model along with the identified selected parameter values for each one of the objective functions of the model, and then select one or more of the content items based on the corresponding score(s) of the one or more content items, such as by selecting a particular highest scoring portion of content items (e.g., the top five highest scoring content items).

At operation 660, the optimization system 216 causes the selected at least one content item to be displayed on the computing device of the target user. For example, the optimization system 216 may include the content item(s) in an e-mail transmitted to the target user or may display the content item(s) on a home page or landing page of an online service.

It is contemplated that any of the other features described within the present disclosure can be incorporated into the method 600.

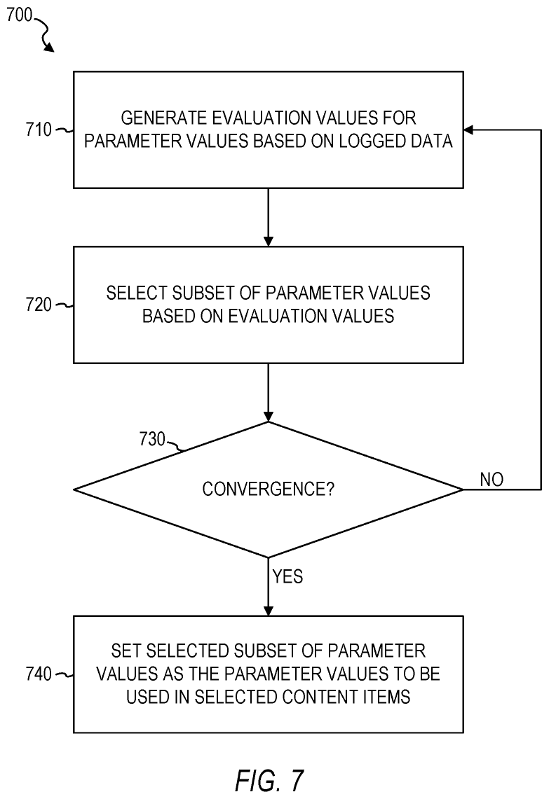

FIG. 7 is a flowchart illustrating a method of selecting, for each one of a plurality of cohorts, one of a plurality of parameter values for each one of a plurality of objective functions, in accordance with an example embodiment. The method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the optimization system 216 of FIGS. 2-3, or any combination of one or more of its modules (e.g., the tuning module 310, the service module 320), as described above.

At operation 710, the optimization system 216, for each one of the plurality of objective functions, generates a corresponding evaluation value for each one of the plurality of parameter values based on the tracking data. For example, the optimization system 216 may generate the corresponding evaluation value using the scoring function Score (m,c) discussed above.

At operation 720, the optimization system 216, for each one of the plurality of objective functions, selects a subset of the plurality of parameter values based on the evaluation values of the subset. In some example embodiments, the selecting the subset of the plurality of parameter values is performed using a Gaussian process algorithm. However, other algorithms for selecting the subset are also within the scope of the present disclosure.

At operation 730, the optimization system 216 determines whether the selected subset of parameter values satisfies a convergence criteria. In some example embodiments, the convergence criteria comprises the selected subset comprising only a single parameter value. If it is determined at operation 730 that the convergence criteria has not been satisfied, then the optimization system 216 returns to operation 710, where evaluation values are generated for the subset of parameter values selected at operation 720, and then proceeds to operation 720, where the optimization system 216 again selects another subset of the parameter values. In some example embodiments, the optimization system 216 repeats operation 710 of generating the corresponding evaluation value and operation 720 of selecting the subset of the plurality of parameter values until a single parameter value satisfies the convergence criteria at operation 730. In some example embodiments, each repeated generating of the corresponding evaluation value at operation7510 uses the most recently selected subset of parameter values for the model. If it is determined at operation 730 that the convergence criteria has been satisfied, then the optimization system 216 proceeds to operation 740, where it sets the most recently selected subset of parameter values as the parameter values to be used for the model in selecting content items for display to users.

It is contemplated that any of the other features described within the present disclosure can be incorporated into the method 700.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a processor configured using software, the processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

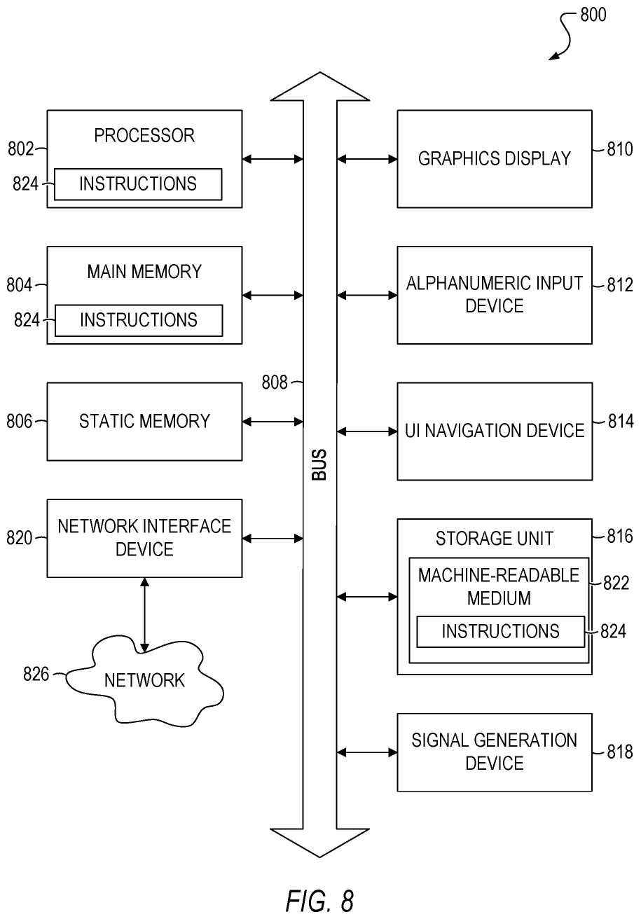

FIG. 8 is a block diagram of an example computer system 800 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a graphics display unit 810 (e.g., a liquid crystal display (LCD) or a cathode ray tube (CRT)). The computer system 800 also includes an alphanumeric input device 812 (e.g., a keyboard or a touch-sensitive display screen), a user interface (UI) navigation device 814 (e.g., a mouse), a storage unit 816, a signal generation device 818 (e.g., a speaker) and a network interface device 820.

The storage unit 816 includes a machine-readable medium 822 on which is stored one or more sets of instructions and data structures (e.g., software) 824 embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions (e.g., instructions 824) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

The following numbered examples are embodiments.

1. A computer-implemented method comprising:
receiving, by a computer system having a memory and at least one hardware processor, logged data (also referred to herein as “tracking data”) for a plurality of cohorts of users of an online service, the logged data of each one of the plurality of cohorts comprising a number of impressions of online content to the cohort, a plurality of parameter values applied to a plurality of objective functions of a model used in selecting the online content for the impressions of the online content to the cohort, a number of contribution actions by the cohort directed towards the online content in response to the impressions, and a number of clicks by the cohort directed towards the online content in response to the impressions;
for each one of the plurality of cohorts, selecting, by the computer system, one of the plurality of parameter values for each one of the plurality of objective functions based on the logged data;
for each one of the plurality of cohorts, storing, by the computer system, the selected parameter value for each one of the objective functions in a database;
identifying, by the computer system, the selected parameter value for each one of the objective functions for a target user of the online service based on an identified cohort for the target user;
selecting, by the computer system, at least one content item for display on a computing device of the target user based on the model using the identified selected parameter values for each one of the objective functions of the model; and
causing, by the computer system, the selected at least one content item to be displayed on the computing device of the target user.

2. The computer-implemented method of example 1, wherein the plurality of cohorts comprise different cohorts that correspond to different levels of interaction of the users with the online service.

3. The computer-implemented method of example 2, wherein the plurality of objective functions correspond to different types of online content.

4. The computer-implemented method of any one of examples 1 to 3, wherein the different types of online content comprise two or more of online content shared by a user, online job postings, and recommendations for connecting with a user.

5. The computer-implemented method of any one of examples 1 to 4, wherein the contribution actions comprise at least one of liking online content, commenting on online content, and sharing online content.

6. The computer-implemented method of any one of examples 1 to 5, wherein the selecting, for each one of the plurality of cohorts, the one of the plurality of parameter values for each one of the plurality of objective functions based on the logged data comprises:
for each one of the plurality of objective functions, generating a corresponding evaluation value for each one of the plurality of parameter values based on the logged data;
for each one of the plurality of objective functions, selecting a subset of the plurality of parameter values based on the evaluation values of the subset; and
repeating the generating the corresponding evaluation value and the selecting the subset of the plurality of parameter values until a single parameter value satisfies a convergence criteria, each repeated generating the corresponding evaluation value using the most recently selected subset of parameter values in place of the plurality of parameter values.

7. The computer-implemented method of any one of examples 1 to 6, wherein the selecting the subset of the plurality of parameter values is performed using a Gaussian process algorithm.
8. A system comprising:
at least one processor; and
a non-transitory computer-readable medium storing executable instructions that, when executed, cause the at least one processor to perform the method of any one of examples 1 to 7.

9. A non-transitory machine-readable storage medium, tangibly embodying a set of instructions that, when executed by at least one processor, causes the at least one processor to perform the method of any one of examples 1 to 7.

10. A machine-readable medium carrying a set of instructions that, when executed by at least one processor, causes the at least one processor to carry out the method of any one of examples 1 to 7.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
receiving, by a computer system having a memory and at least one hardware processor, logged data for a plurality of cohorts of users of an online service, the logged data of each one of the plurality of cohorts comprising a number of impressions of online content to the cohort, a plurality of parameter values applied to a plurality of objective functions of a model used in selecting the online content for the impressions of the online content to the cohort, a number of contribution actions by the cohort directed towards the online content in response to the impressions, and a number of clicks by the cohort directed towards the online content in response to the impressions;
for each one of the plurality of cohorts, selecting, by the computer system, one of the plurality of parameter values for each one of the plurality of objective functions based on the logged data;
for each one of the plurality of cohorts, storing, by the computer system, the selected parameter value for each one of the objective functions in a database;
identifying, by the computer system, the selected parameter value for each one of the objective functions for a target user of the online service based on an identified cohort for the target user;
selecting, by the computer system, at least one content item for display on a computing device of the target user based on the model using the identified selected parameter values for each one of the objective functions of the model; and
causing, by the computer system, the selected at least one content item to be displayed on the computing device of the target user.

2. The computer-implemented method of claim 1, wherein the plurality of cohorts comprise different cohorts that correspond to different levels of interaction of the users with the online service.

3. The computer-implemented method of claim 1, wherein the plurality of objective functions correspond to different types of online content.

4. The computer-implemented method of claim 3, wherein the different types of online content comprise two or more of online content shared by a user, online job postings, and recommendations for connecting with a user.

5. The computer-implemented method of claim 1, wherein the contribution actions comprise at least one of liking online content, commenting on online content, and sharing online content.

6. The computer-implemented method of claim 1, wherein the selecting, for each one of the plurality of cohorts, the one of the plurality of parameter values for each one of the plurality of objective functions based on the logged data comprises:
for each one of the plurality of objective functions, generating a corresponding evaluation value for each one of the plurality of parameter values based on the logged data;
for each one of the plurality of objective functions, selecting a subset of the plurality of parameter values based on the evaluation values of the subset; and
repeating the generating the corresponding evaluation value and the selecting the subset of the plurality of parameter values until a single parameter value satisfies a convergence criteria, each repeated generating the corresponding evaluation value using the most recently selected subset of parameter values in place of the plurality of parameter values.

7. The computer-implemented method of claim 6, wherein the selecting the subset of the plurality of parameter values is performed using a Gaussian process algorithm.

8. A system comprising:
at least one hardware processor; and
a non-transitory machine-readable medium embodying a set of instructions that, when executed by the at least one hardware processor, cause the at least one processor to perform operations, the operations comprising:
receiving logged data for a plurality of cohorts of users of an online service, the logged data of each one of the plurality of cohorts comprising a number of impressions of online content to the cohort, a plurality of parameter values applied to a plurality of objective functions of a model used in selecting the online content for the impressions of the online content to the cohort, a number of contribution actions by the cohort directed towards the online content in response to the impressions, and a number of clicks by the cohort directed towards the online content in response to the impressions;
for each one of the plurality of cohorts, selecting one of the plurality of parameter values for each one of the plurality of objective functions based on the logged data;
for each one of the plurality of cohorts, storing the selected parameter value for each one of the objective functions in a database;
identifying the selected parameter value for each one of the objective functions for a target user of the online service based on an identified cohort for the target user;
selecting at least one content item for display on a computing device of the target user based on the model using the identified selected parameter values for each one of the objective functions of the model; and
causing the selected at least one content item to be displayed on the computing device of the target user.

9. The system of claim 8, wherein the plurality of cohorts comprise different cohorts that correspond to different levels of interaction of the users with the online service.

10. The system of claim 8, wherein the plurality of objective functions correspond to different types of online content.

11. The system of claim 10, wherein the different types of online content comprise two or more of online content shared by a user, online job postings, and recommendations for connecting with a user.

12. The system of claim 8, wherein the contribution actions comprise at least one of liking online content, commenting on online content, and sharing online content.

13. The system of claim 8, wherein the selecting, for each one of the plurality of cohorts, the one of the plurality of parameter values for each one of the plurality of objective functions based on the logged data comprises:
for each one of the plurality of objective functions, generating a corresponding evaluation value for each one of the plurality of parameter values based on the logged data;
for each one of the plurality of objective functions, selecting a subset of the plurality of parameter values based on the evaluation values of the subset; and
repeating the generating the corresponding evaluation value and the selecting the subset of the plurality of parameter values until a single parameter value satisfies a convergence criteria, each repeated generating the corresponding evaluation value using the most recently selected subset of parameter values in place of the plurality of parameter values.

14. The system of claim 13, wherein the selecting the subset of the plurality of parameter values is performed using a Gaussian process algorithm.

15. A non-transitory machine-readable medium embodying a set of instructions that, when executed by at least one hardware processor, cause the processor to perform operations, the operations comprising:
receiving logged data for a plurality of cohorts of users of an online service, the logged data of each one of the plurality of cohorts comprising a number of impressions of online content to the cohort, a plurality of parameter values applied to a plurality of objective functions of a model used in selecting the online content for the impressions of the online content to the cohort, a number of contribution actions by the cohort directed towards the online content in response to the impressions, and a number of clicks by the cohort directed towards the online content in response to the impressions;
for each one of the plurality of cohorts, selecting one of the plurality of parameter values for each one of the plurality of objective functions based on the logged data;
for each one of the plurality of cohorts, storing the selected parameter value for each one of the objective functions in a database;
identifying the selected parameter value for each one of the objective functions for a target user of the online service based on an identified cohort for the target user;
selecting at least one content item for display on a computing device of the target user based on the model using the identified selected parameter values for each one of the objective functions of the model; and
causing the selected at least one content item to be displayed on the computing device of the target user.

16. The non-transitory machine-readable medium of claim 15, wherein the plurality of cohorts comprise different cohorts that correspond to different levels of interaction of the users with the online service.

17. The non-transitory machine-readable medium of claim 15, wherein the plurality of objective functions correspond to different types of online content.

18. The non-transitory machine-readable medium of claim 17, wherein the different types of online content comprise two or more of online content shared by a user, online job postings, and recommendations for connecting with a user.

19. The non-transitory machine-readable medium of claim 15, wherein the contribution actions comprise at least one of liking online content, commenting on online content, and sharing online content.

20. The non-transitory machine-readable medium of claim 15, wherein the selecting, for each one of the plurality of cohorts, the one of the plurality of parameter values for each one of the plurality of objective functions based on the logged data comprises:
for each one of the plurality of objective functions, generating a corresponding evaluation value for each one of the plurality of parameter values based on the logged data;
for each one of the plurality of objective functions, selecting a subset of the plurality of parameter values based on the evaluation values of the subset; and
repeating the generating the corresponding evaluation value and the selecting the subset of the plurality of parameter values until a single parameter value satisfies a convergence criteria, each repeated generating the corresponding evaluation value using the most recently selected subset of parameter values in place of the plurality of parameter values.
